(19) United States
(12) Patent Application Publication
(10) Pub. No.: US 2002/0043919 A1
(43) Pub. Date: Apr. 18, 2002

(54) Shadow mask assembly for color cathode ray tube

(76) Inventors: Jun-Kyo In, Suwon-city (KR); Do-Hun Pyen, Yongin-city (KR)

Correspondence Address: Robert E. Bushnell, Suite 300, 1522 K Street, N.W., Washington, DC, 20005-1202, US

(21) Appl. No.: 09/946,677

(22) Filed: Sep. 6, 2001

(30) Foreign Application Priority Data
Oct. 10, 2000 (KR) 2000-59572

(51) Int. Cl. H01J 29/80

(52) U.S. Cl. 313/407

(57) ABSTRACT

A shadow mask assembly for a cathode ray tube (CRT) includes a color selection electrode provided with a large number of beam-passing apertures, a mask frame having a pair of supporting members and a pair of elastic members disposed so as to maintain a predetermined distance between the supporting members, a plurality of spring holders mounted on the supporting and elastic members, each of the spring holders comprising a spring fixing portion and a frame fixing portion that are arranged in a longitudinal direction of the spring holder, one of the spring and frame fixing portions being formed of a bimetal and the other being formed of a uni-metal, and a spring for supporting the mask frame on an inner surface of a cathode ray tube panel, the spring having a first end fixed on the spring fixing portion of the spring holder and a second end fixed on a stud pin embedded in an inner surface of the cathode ray tube panel.

### CLAIM OF PRIORITY

This application makes reference to, incorporates the same herein, and claims all benefits accruing under 35 U.S.C. §119 from my application MASK ASSEMBLY FOR CATHODE RAY TUBE filed with the Korean Industrial Property Office on Oct. 10, 2000 and there duly assigned Serial No. 2000-59572.

### BACKGROUND OF THE INVENTION

1. Technical Field

The present invention relates to a shadow mask assembly for a color cathode ray tube (CRT).

2. Related Art

In a shadow mask assembly, a tensioned mask can be provided with a large number of beam-passing apertures and welded on supporting members in a state where it is tensioned in a vertical direction. The supporting members can be connected to each other by a pair of lateral elastic members such that the supporting members and the lateral elastic members constitute a mask frame for supporting the tensioned mask. The lateral elastic members apply tension to the tensioned mask.

We have found that it is desirable to compensate for a thermal expansion of the shadow mask. However, in a spring holder, the length of the spring holder is pre-set and fixed according to a distance between the shadow mask and an inner surface of a panel, so it is impossible to change the length of the spring holder. It is difficult to design a spring holder that can properly compensate for thermal expansion of the shadow mask assembly. Efforts have been made to improve masks and components related to masks.

Exemplars of recent efforts in the art of masks include U.S. Pat. No. 5,594,300 to Nosker et al. entitled COLOR PICTURE TUBE HAVING A TENSIONED MASK AN COMPLIANT SUPPORT FRAME ASSEMBLY, issued on Jan. 14, 1997, U.S. Pat. No. 3,943,399 to Sedivy, entitled SHADOW-MASK COLOR CATHODE RAY TUBE WITH IMPROVED MASK SUSPENSION SYSTEM, issued on Mar. 9, 1976, U.S. Pat. No. 5,808,405 to Koh, entitled ELASTIC NON-WELDED SHADOW MASK SUPPORT ASSEMBLY FOR COLOR CATHODE-RAY TUBE, issued on Sep. 15, 1998, U.S. Pat. No. 5,898,259 to Reyal, entitled SHADOW MASK FRAME OF A CATHODE RAY TUBE, ITS PROCESS OF MANUFACTURE, AND SUSPENSION ELEMENT OF A SHADOW MASK FRAME, issued on Apr. 27, 1999, U.S. Pat. No. 5,949,183 to Saita et al., entitled COLOR SELECTING MECHANISM OF CATHODE-RAY TUBE AND COLOR SELECTING MECHANISM FRAME THEREOF, issued on Sep. 7, 1999, U.S. Pat. No. 6,097,142 to Ko, entitled SHADOW MASK HAVING AN EFFECTIVE FACE AREA AND INEFFECTIVE FACE AREA, issued on Aug. 1, 2000, U.S. Pat. No. 4,798,992 to Ichigaya et al., entitled COLOR CATHODE-RAY TUBE WITH ELECTRON BEAM SELECTION MASK SUPPORT STRUCTURE, issued on Jan. 17, 1989, U.S. Pat. No. 4,886,997 to Inoue et al., entitled COLOR PICTURE TUBE WITH SHADOW MASK SUPPORT ASSEMBLY, issued on Dec. 12, 1989, U.S. Pat. No. 5,209,900 to Nakamura et al., entitled HIGH-FINENESS SHADOW MASK MATERIAL AND PROCESS FOR PRODUCING THE SAME, issued on May 11, 1993, and U.S. Pat. No. 5,376,863 to Kim et al., entitled ELASTIC SUPPORTING MEMBER FOR SHADOW MASK FRAME, issued on Dec. 27, 1994.

While these recent efforts provide advantages, I note that they fail to adequately provide an efficiently and conveniently improved shadow mask assembly for color cathode ray tube.

### SUMMARY OF THE INVENTION

Therefore, the present invention has been made in an effort to solve the above-described problems.

It is an objective of the present invention to provide a shadow mask assembly of a color cathode ray tube (CRT) that has an improved spring holder that is designed to properly compensate for thermal expansion of the shadow mask assembly according to a tension value of the tensioned mask as well as a structure of the mask frame.

It is an objective of the present invention to provide a more accurate control in moving a shadow mask frame assembly.

To achieve the above objectives and others, the present invention provides a shadow mask assembly for a cathode ray tube, which comprises: a color selection electrode provided with a large number of beam-passing apertures; a mask frame comprising a pair of supporting members disposed to correspond to both longitudinal sides of the color selection electrode and a pair of elastic members disposed so as to maintain a predetermined distance between the supporting members; a plurality of spring holders mounted on the supporting and elastic members, each of the spring holders comprising a spring fixing portion and a frame fixing portion that are arranged in a longitudinal direction of the spring holder, one of the spring and frame fixing portions being formed of a bimetal and the other being formed of a uni-metal; and a spring for supporting the mask frame on an inner surface of a cathode ray tube panel, the spring having a first end fixed on the spring fixing portion of the spring holder and a second end fixed on a stud pin embedded in an inner surface of the cathode ray tube panel.

According to an embodiment of the present invention, the spring fixing portion is formed of the bimetal and the frame fixing portion is formed of the uni-metal. The bimetal comprises a low expansion member and a high expansion member that are attached to each other in the longitudinal direction of the spring holder, the spring holders mounted on the supporting members of the mask frame are disposed such that the low expansion members face an inner side of the mask frame, and the spring holders mounted on the elastic members are disposed such that the high expansion member faces the inner side of the mask frame.

The uni-metal is formed by integrally extending from one of the low and high expansion members. Preferably, the high expansion member is formed of an SUS-type material. The SUS-type material is a stainless steel material. The term “SUS” refers to a category or standard related to the Siam United Steel Company. Preferably, the low expansion member is formed of an INVAR-type material having a low thermal expansion property.

According to another embodiment of the present invention, the frame fixing portion is formed of the bimetal, and the spring fixing portion is formed of the uni-metal.

According to still another embodiment of the present invention, the frame fixing portion of the spring holder mounted on the supporting members is formed of the bimetal, and the spring fixing portion of the spring holder mounted on the elastic member is formed of the bimetal.

To achieve these and other objects in accordance with the principles of the present invention, as embodied and broadly described, the present invention provides a shadow mask apparatus, comprising: a color selection electrode forming a plurality of beam-passing apertures; a mask frame supporting said color selection electrode and having a tensioning device applying tension to said color selection electrode; at least one primary spring holder mounted on said mask frame, said at least one primary spring holder having a primary spring fixing portion and a primary frame fixing portion, one of said two primary portions being formed of a bimetal and the other one of said two primary portions being formed of a uni-metal, said primary frame fixing portion being secured to said mask frame; and a first spring being secured to said primary spring fixing portion and being coupled to a cathode ray tube panel, said first spring supporting said mask frame on the cathode ray tube panel.

To achieve these and other objects in accordance with the principles of the present invention, as embodied and broadly described, the present invention provides a shadow mask apparatus, comprising: a color selection electrode forming a plurality of beam-passing apertures; a mask frame supporting said color selection electrode and having a tensioning device applying tension to said color selection electrode; a first primary spring holder having a first primary spring fixing portion and a first primary frame fixing portion, said first primary frame fixing portion being secured to said tensioning device of said mask frame; a second primary spring holder having a second primary spring fixing portion and a second primary frame fixing portion, said second primary frame fixing portion being secured to said tensioning device of said mask frame; a first spring being secured to said first primary spring fixing portion and being coupled to a cathode ray tube panel, said first spring supporting said mask frame on the cathode ray tube panel; and a second spring being secured to said second primary spring fixing portion and being coupled to the cathode ray tube panel, said second spring supporting said mask frame on the cathode ray tube panel; one portion selected from among said first primary frame fixing portion and said first primary spring fixing portion being formed of a bimetal and the other portion being formed of a uni-metal, one portion selected from among said second primary frame fixing portion and said second primary spring fixing portion being formed of a bimetal and the other portion being formed of a uni-metal.

To achieve these and other objects in accordance with the principles of the present invention, as embodied and broadly described, the present invention provides a shadow mask apparatus, comprising: a color selection electrode being provided with a plurality of beam-passing apertures, said color selection electrode having two longitudinal sides; a mask frame having two supporting members and two elastic members, each one of said two supporting members being disposed to respectively correspond to each one of said two longitudinal sides of said color selection electrode, said two elastic members being disposed to maintain a predetermined distance between said two supporting members; a plurality of spring holders mounted on said supporting and elastic members, each one of said spring holders having two portions, said two portions corresponding to one spring fixing portion and one frame fixing portion, each one of said spring holders having one of said two portions formed of a bimetal and the other one of said two portions formed of a uni-metal; and a plurality of springs supporting said mask frame on an inner surface of a panel, each one of said springs having a first end fixed on a respective one of said spring holders and a second end fixed on a stud pin embedded in an inner surface of the panel, said first end being fixed on said spring fixing portion of said respective one of said spring holders.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1A is a perspective view of a shadow mask assembly of a color cathode ray tube, not in accordance with the principles of the present invention;

FIG. 1B is an enlarged view of a circled portion I of FIG. 1A, not in accordance with the principles of the present invention;

FIG. 2A is a perspective view of a first embodiment of a shadow mask assembly of a color cathode ray tube, in accordance with the principles of the present invention;

FIG. 2B is an enlarged view of a circled portion I of FIG. 2A, in accordance with the first embodiment of the present invention;

FIG. 2C is an enlarged view of a circled portion II of FIG. 2A, in accordance with the first embodiment of the present invention;

FIGS. 2D to 2G illustrate side views of the spring holder and related components shown in FIG. 2C, in accordance with the first embodiment of the present invention;

FIG. 2H shows a side view of a modified example of the arrangement of the spring holder and related components shown in FIG. 2C, in accordance with the first embodiment of the present invention;

FIGS. 2I and 2J show a side view of a modified example of the spring holder shown in FIG. 2C;

FIG. 3A is a perspective view of a second embodiment of a shadow mask assembly of a color cathode ray tube, in accordance with the principles of the present invention;

FIG. 3B is an enlarged view of a circled portion I of FIG. 3A, in accordance with the second embodiment of the present invention;

FIG. 3C is an enlarged view of a circled portion II of FIG. 3A, in accordance with the second embodiment of the present invention;

FIG. 4A is a perspective view of a third embodiment of a shadow mask assembly of a color cathode ray tube, in accordance with the principles of the present invention;

FIG. 4B is an enlarged view of a circled portion I of FIG. 4A, in accordance with the third embodiment of the present invention;

FIG. 4C is an enlarged view of a circled portion II of FIG. 4A, in accordance with the third embodiment of the present invention;

FIG. 5 is a perspective view of a modified example of a spring assembly, in accordance with the principles of the present invention; and

FIG. 6 is a view of a cathode ray tube panel having a stud pin, in accordance with the principles of the present invention.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

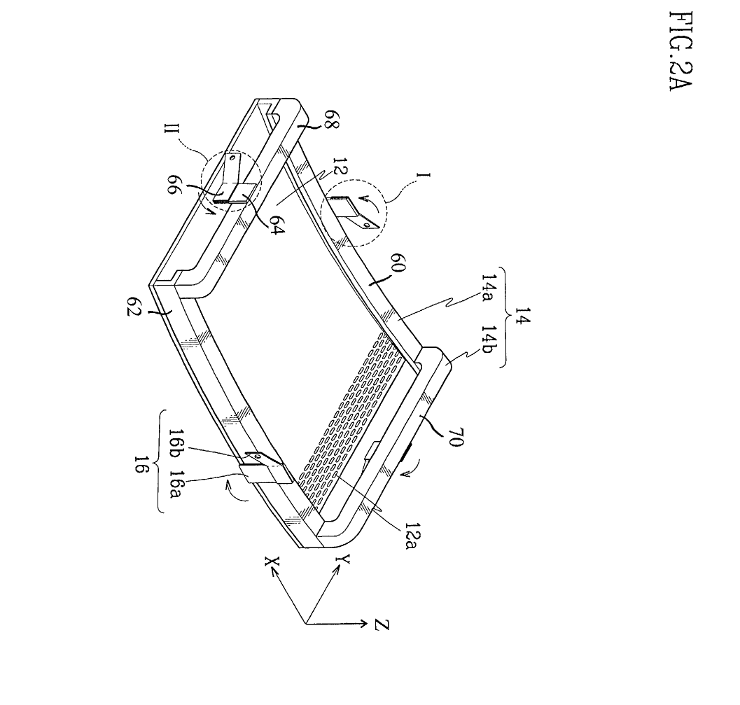

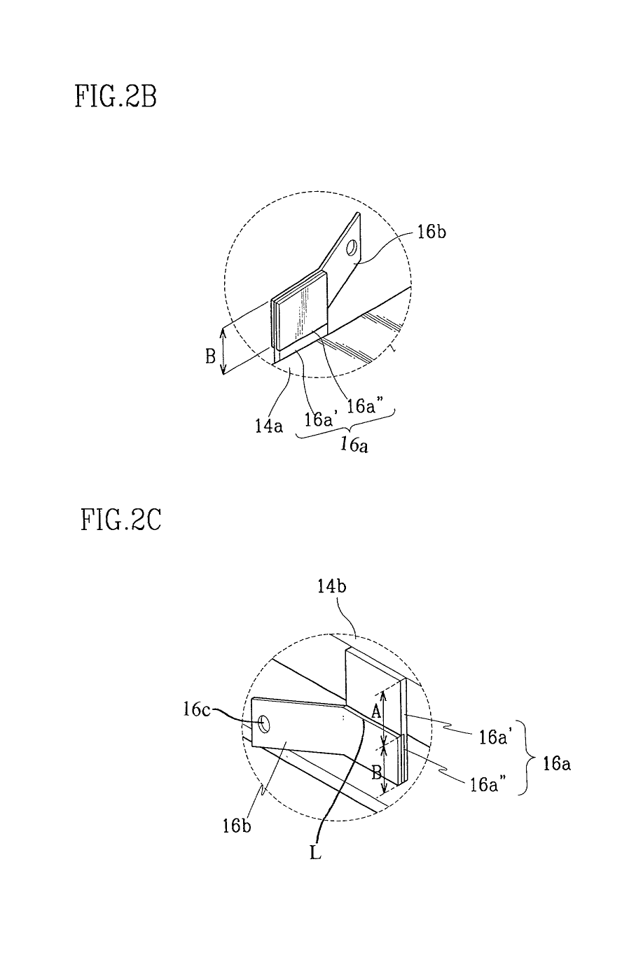

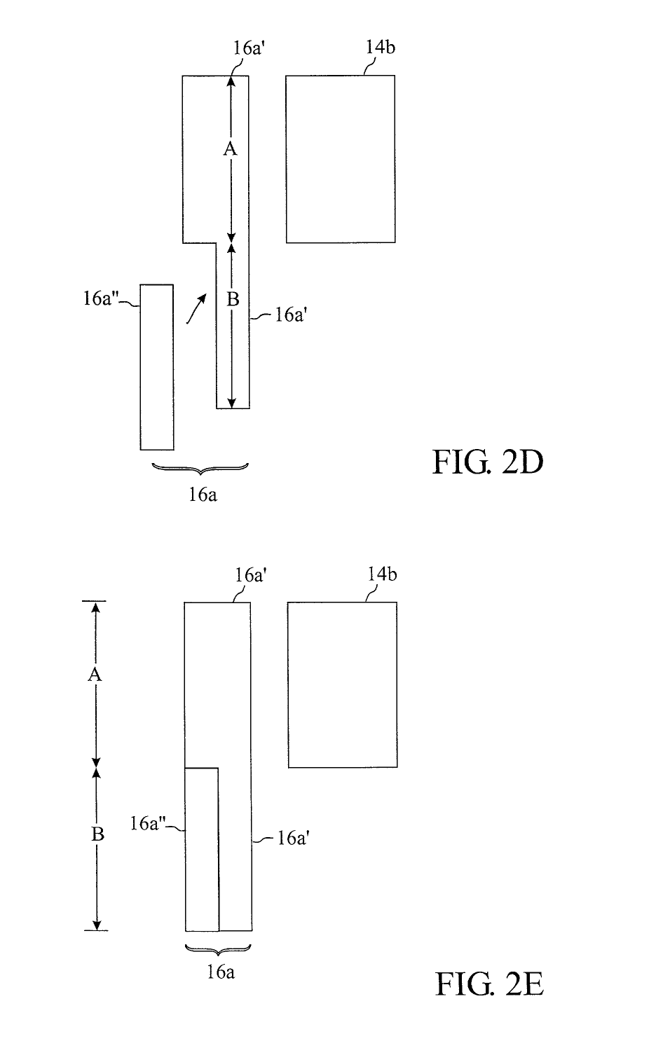

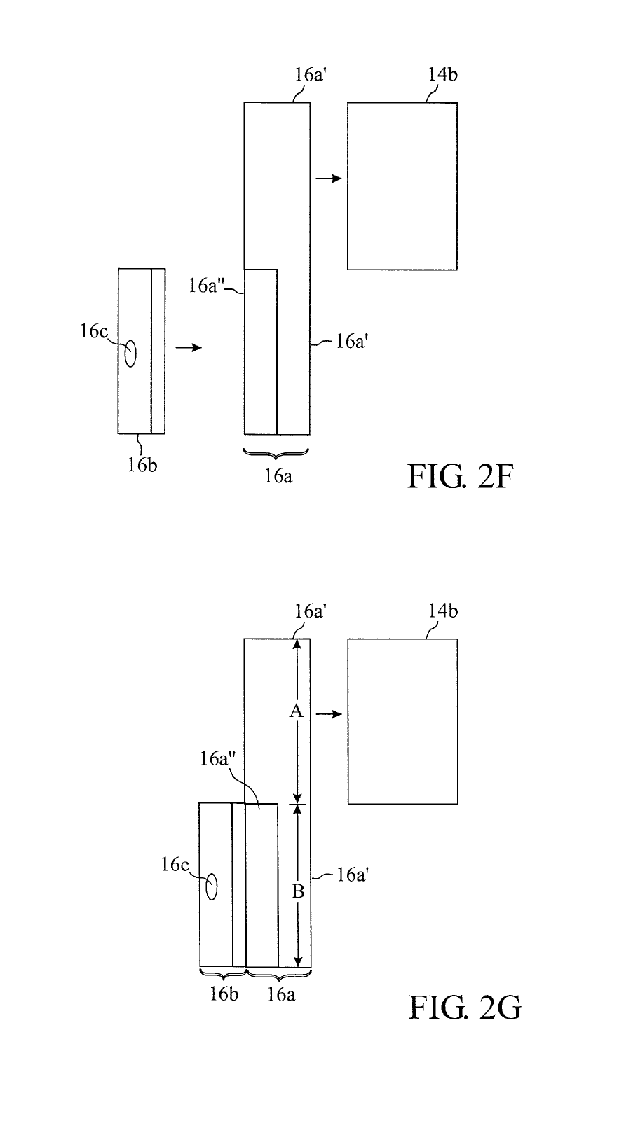

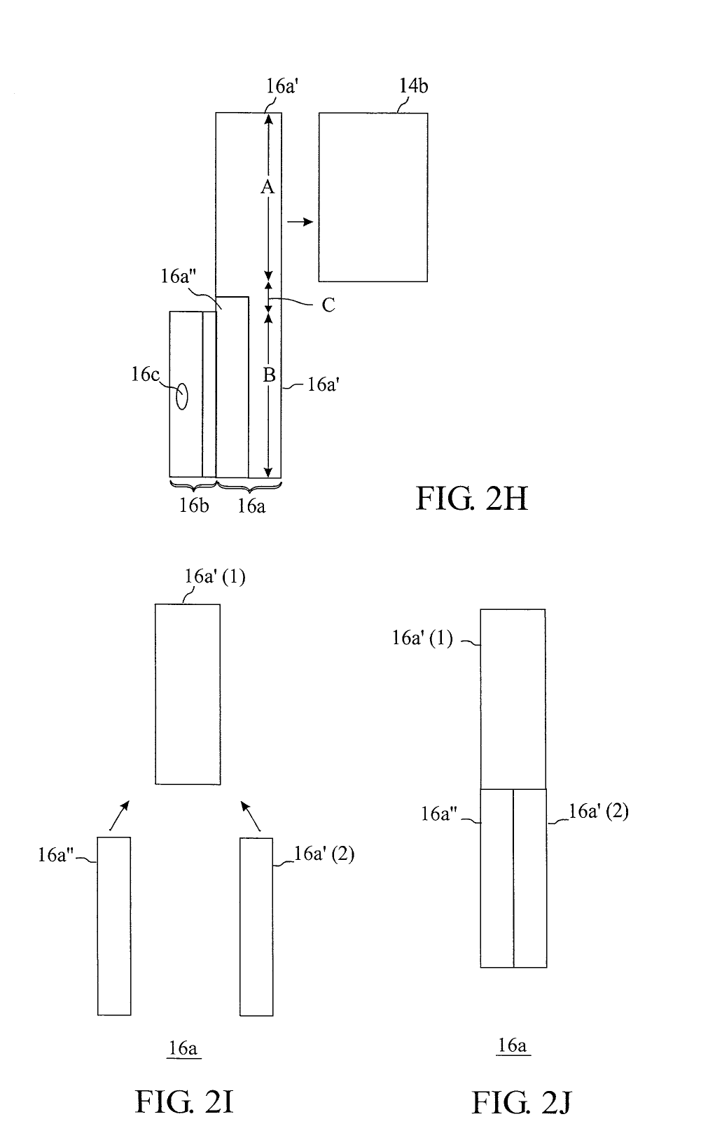

Illustrative embodiments of the invention are described below. In the interest of clarity, not all features of an actual implementation are described. In the following description, well-known functions or constructions are not described in detail since they would obscure the invention in unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure. Additionally, the teachings of the embodiments and the modified examples disclosed can be combined. For example, the arrangement of features in FIG. 5 can be applied to the embodiments shown in FIGS. 2A through 4C, as explained below.

In a shadow mask assembly, a tensioned mask can be provided with a large number of beam-passing apertures and welded on supporting members in a state where it is tensioned in a vertical direction. The supporting members can be connected to each other by a pair of lateral elastic members such that the supporting members and the lateral elastic members constitute a mask frame for supporting the tensioned mask.

A spring assembly for mounting the mask frame supporting the tensioned mask on an inner surface of a cathode ray tube panel can be mounted on each outer side of the supporting members and the elastic members. The spring assembly comprises a spring holder, one end portion of which is welded on the mask frame and a spring, one end portion of which is fixed on the spring holder and the other end portion of which is coupled to a stud pin, embedded in the inner surface of the cathode ray tube panel, through a coupling hole formed through the other end portion. The spring holder is formed of a bimetal member comprising a high-expansion member and a low-expansion member, which are attached to each other in their longitudinal directions.

Accordingly, the shadow mask assembly is mounted on the inner surface of the cathode ray tube panel by the spring assemblies. When thermal energy is increased by high-current aging or electron beam scanning in a state where the shadow mask assembly is mounted on the cathode ray tube panel, the spring holder is bent in a predetermined direction by its bimetal characteristics, thereby compensating for thermal expansion of the tensioned mask and the mask frame. That is, the spring assemblies finally compensate for thermal expansion of the shadow mask and the mask frame, which is caused by the electron beams striking them.

The tension value of the tensioned mask and the structure of the mask frame are varied according to manufacturing company and model, and thermal expansion of the shadow mask assembly from the increase of thermal energy is varied according to the tension value of the tensioned mask and the structure of the mask frame.

Accordingly, the spring holder used for compensating for thermal expansion of the shadow mask assembly should be designed to properly compensate for thermal expansion with respect to many different types of mask structures and different values of tension.

To vary the thermal expansion-compensating amount, the high and low-expansion members of the spring holder should be changed in their thickness, material, or length. However, in a spring holder not in accordance with the principles of the present invention, the length thereof is pre-set and fixed according to a distance between the shadow mask and the inner surface of the panel, so it is impossible to change the length of the spring holder.

Therefore, only the change of the material and the thickness of the expansion members can allow the amount of thermal expansion compensation to be varied. Since all of the bimetal characteristics of a variety of materials for the high and low-expansion members should be recognized, it is difficult to design a spring holder that can properly compensate for thermal expansion of the shadow mask assembly. Preferred embodiments of the present invention will be described in detail with reference to the accompanying drawings.

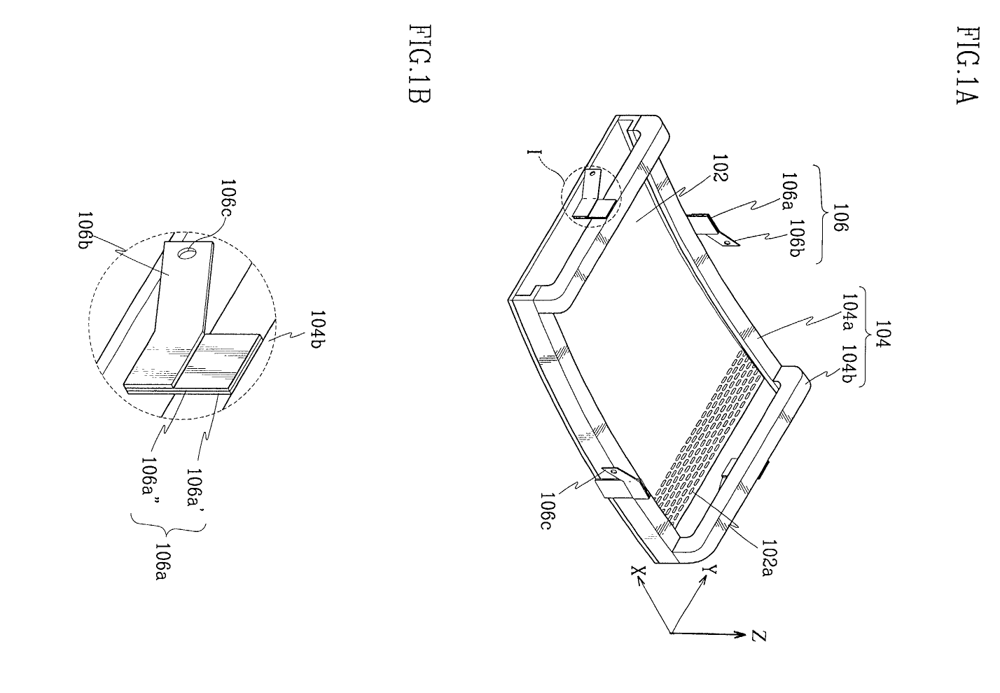

FIGS. 1A and 1B show a shadow mask assembly which is not in accordance with the principles of the present invention. As shown in FIG. 1A, a tensioned mask 102 provided with a large number of beam-passing apertures 102a is welded on supporting members 104a in a state where it is tensioned in a vertical direction (in a direction of a Y-axis in FIG. 1A). The supporting members 104a are connected to each other by a pair of lateral elastic members 104b such that the supporting members 104a and the lateral elastic members 104b constitute a mask frame 104 for supporting the tensioned mask 102.

In addition, a spring assembly 106 for mounting the mask frame 104 supporting the tensioned mask 102 on an inner surface of a cathode ray tube panel is mounted on each outer side of the supporting members 104a and the elastic members 104b. As shown in FIG. 1B, the spring assembly 106 comprises a spring holder 106a, one end portion of which is welded on the mask frame 104 and a spring 106b, one end portion of which is fixed on the spring holder 106a and the other end portion of which is coupled to a stud pin (not shown), embedded in the inner surface of the cathode ray tube panel (not shown), through a coupling hole 106c formed through the other end portion. The spring holder 106a is formed of a bimetal member comprising a high-expansion member 106a′ and a low-expansion member 106a″, which are attached to each other in their longitudinal directions.

As shown in FIGS. 1A and 1B, the spring holder 106a is made entirely of the bimetal. The spring holder 106a is made entirely of the high expansion member 106a′ and the low expansion member 106a″. There is no uni-metal portion of the spring holder 106a.

Accordingly, the shadow mask assembly is mounted on the inner surface of the cathode ray tube panel by the spring assemblies 106. When thermal energy is increased by high-current aging or electron beam scanning in a state where the shadow mask assembly is mounted on the cathode ray tube panel, the spring holder 106a is bent in a predetermined direction by its bimetal characteristics, thereby compensating for thermal expansion of the tensioned mask 102 and the mask frame 104. That is, the spring assemblies 106 finally compensate for thermal expansion of the shadow mask and the mask frame, which is caused by the electron beams striking them.

The tension value of the tensioned mask and the structure of the mask frame are varied according to manufacturing company and model, and thermal expansion of the shadow mask assembly from the increase of thermal energy is varied according to the tension value of the tensioned mask and the structure of the mask frame.

Accordingly, the spring holder used for compensating for thermal expansion of the shadow mask assembly should be designed to properly compensate for thermal expansion with respect to many different types of mask structures and different values of tension.

The high expansion member and the low expansion member are the components of the bimetal material. To vary the thermal expansion-compensating amount, the high and low-expansion members of the spring holder should be changed in their thickness, material, or length. However, in the spring holder of FIGS. 1A and 1B, the length of the high and low expansion members is pre-set and fixed according to a distance between the shadow mask and the inner surface of the panel, so it is impossible to change the length of the spring holder. The spring holder 106a is entirely made of a bimetal material, and the components of the bimetal material have a length that is determined by the overall size of the spring holder, as most clearly shown in FIG. 1B.

Therefore, only a change of the components in the bimetal material, or a change of the thickness of the components in the bimetal material, can allow the amount of thermal expansion compensation to be varied. Since all of the bimetal characteristics of a variety of materials for the high and low-expansion members should be recognized, it is difficult to design a spring holder that can properly compensate for thermal expansion of the shadow mask assembly.

The above problems are solved by manufacturing and arranging spring holders as shown in FIGS. 2A through 5.

FIG. 2A is a perspective view of a first embodiment of a shadow mask assembly of a color cathode ray tube, in accordance with the principles of the present invention. FIG. 2B is an enlarged view of a circled portion I of FIG. 2A, in accordance with the first embodiment of the present invention. FIG. 2C is an enlarged view of a circled portion II of FIG. 2A, in accordance with the first embodiment of the present invention. FIGS. 2D to 2G illustrate side views of the spring holder and related components shown in FIG. 2C, in accordance with the first embodiment of the present invention. FIG. 2H shows a side view of a modified example of the arrangement of the spring holder and related components shown in FIG. 2C, in accordance with the first embodiment of the present invention. FIGS. 2I and 2J show a side view of a modified example of the spring holder shown in FIG. 2C, in accordance with a first embodiment of the present invention.

As shown in FIG. 2C, the present invention includes a spring holder 16a that is partly bimetal and partly uni-metal. This is an advantage over the spring holder 106a shown in FIG. 1B. The present invention, with the combination of uni-metal and bimetal in the spring holder, allows for more accurate control in moving the shadow mask frame assembly.

Referring first to FIG. 2A, a shadow mask assembly comprises a shadow mask 12 functioning as a color selection electrode, a mask frame 14 for supporting the shadow mask 12, and a plurality of spring assemblies 16 for suspending the mask frame 14 on the panel.

To manufacture the shadow mask 12, a large number of beam-passing apertures 12a are first formed on a thin plate made of an aluminum killed (AK) steel or an INVAR steel through a well-known photolithography process, and a final shape of the shadow mask 12 is completed through a drawing process.

At this point, the mask 12 is fixed on the mask frame 14 in a state where it is tensioned in at least one direction. That is, the shadow mask 12 is generally tensioned in a direction of a Y-axis in the drawing (that is, a vertical direction of the screen). The mask frame 14 comprises a pair of supporting members 14a disposed in a direction of an X-axis in the drawing to correspond to both longitudinal edges (or sides) of the mask 12, and a pair of elastic members 14b disposed in a direction of the Y-axis so as to maintain a predetermined distance between the supporting members 14a.

As shown in FIG. 2A, the Y-axis corresponds to a vertical direction, the X-axis corresponds to a horizontal direction. The Z-axis corresponds to a third direction that is perpendicular to both the vertical and horizontal directions.

Four spring assemblies 16 are provided on the mask frame 14 so as to suspend the mask frame 14 on the panel. Each of the spring assemblies 16 comprises a spring holder 16a and a spring 16b fixed on the spring holder 16a. The spring holder 16a is provided with a frame fixing portion A fixed on the frame 14 and a spring fixing portion B on which one end portion of the spring 16b is fixed. The other end portion of the spring 16b is fixed on a stud pin (not shown) embedded in the inner surface of the panel (not shown).

The present invention, as shown in FIG. 2A, shows two elastic members 14b and two supporting members 14a. The two elastic members 14b provide tension to the tensioned shadow mask 12. Each one of these four members is shown to have one spring holder.

One individual elastic member can be considered to be one tensioning device. Also, two or more elastic members can be considered together as a group to be one tensioning device. The two elastic members 14b can also be referred to as tensioned members.

One individual supporting member can be considered to be one supporting device. Also, two or more supporting members can be considered together as a group to be one supporting device. Two supporting members 14a are shown in FIG. 2A.

As shown in FIGS. 2B and 2C, the spring holder 16a comprises a bimetal portion and a uni-metal portion. The bimetal portion has a high expansion member 16a′ made of an SUS-type material, and a low expansion member 16a″ made of an INVAR-type material and attached on the high expansion member 16a′. The uni-metal portion is integrally formed with the bimetal portion. The uni-metal portion is integrally extended from the bimetal portion. In other words, the uni-metal portion integrally extends from one member selected from the high expansion member 16a′ and the low expansion member 16a″. As shown in FIG. 2C, in the spring fixing portion B, the high expansion member 16a′ and the low expansion member 16a″ are attached to each other side by side in the horizontal direction along the X axis.

For identification and discussion purposes, the spring holders 16a on the elastic members 14b can be referred to as primary spring holders, and the spring holders 16a on the supporting members 14a can be referred to as secondary spring holders. Accordingly, on a primary spring holder, the frame fixing portion A can be referred to as a primary frame fixing portion, and the spring fixing portion B can be referred to as a primary spring fixing portion. Also, on a secondary spring holder, the frame fixing portion A can be referred to as a secondary frame fixing portion, and the spring fixing portion B can be referred to as a secondary spring fixing portion. In this instance, the terms primary and secondary are used to facilitate identification and discussion of the features of the present invention.

As shown in FIG. 2B, the spring holder 16a is arranged so that the bimetal portion is over the uni-metal portion or on top of the uni-metal portion. The bimetal portion has the low expansion member 16a″ facing toward the inner side of mask frame 14. In other words, the bimetal portion has the low expansion member 16a″ facing toward a central region of the mask 12.

The bimetal portion also has the high expansion member 16a′ facing away from the inner side of mask frame 14. The uni-metal portion has the high expansion member 16a′ integrally extended down from the high expansion member 16a′ of the bimetal portion. Thus, the uni-metal portion is integrally formed with the bimetal portion.

As shown in FIG. 2A, the shadow mask 12 has a face and has four edges. The face has the beam passing apertures 12a. The supporting members 14a support the upper and lower edges of the mask 12. In FIG. 2A, the supporting members 14a are individually identified as a first supporting member 60 and a second supporting member 62. The elastic members 14b are connected to the supporting members 14a near the left and right edges of the mask 12. In FIG. 2A, the elastic members 14a are individually identified as a first elastic member 68 and a second elastic member 70. A frame fixing portion 64 and a spring fixing portion 66 are shown in FIG. 2A. The frame fixing portion 64 shown in FIG. 2A is the same as the frame fixing portion A shown in FIG. 2C. The spring fixing portion 66 shown in FIG. 2A is the same as the spring fixing portion B shown in FIG. 2C.

The frame fixing portion 64 and the spring fixing portion 66 can be said to be stacked one on top of the other, substantially along the Z axis, as depicted in FIG. 2A. The frame fixing portion 64 and the spring fixing portion 66 can be said to be stacked one over the other, substantially along the Z axis, as depicted in FIG. 2A.

The supporting members 14a can extend in a horizontal direction without being exactly parallel to the X axis, and can extend substantially in a horizontal direction without being exactly parallel to the X axis. The supporting members 14a can have curvature. The elastic members 14b can extend in a vertical direction without being exactly parallel to the Y axis, and can extend substantially in a vertical direction without being exactly parallel to the Y axis. The elastic members 14b can have curvature.

When the face of the shadow mask 12 is oriented to be along the vertical direction, along the Y-axis as shown in FIG. 2A, one supporting member 60 supports the upper edge of the mask 12, and the other supporting member 62 supports the lower edge of the mask 12. Also, when the mask 12 has that orientation, one elastic member 68 is connected to the two supporting members 14a at a left region of the face of the mask 12 near the left edge of the mask 12, and the other elastic member 70 is connected to the two supporting members 14a at a right region of the face of the mask 12 near the right edge of the mask 12, as shown in FIG. 2A. In addition, when the mask 12 has that orientation, the frame fixing portion 64 and the spring fixing portion 66 are arranged along the Z axis, as shown in FIG. 2A.

As illustrated in FIG. 2A, the spring fixing portion 66 is below the frame fixing portion 64, as arranged along the Z axis. The spring fixing portion 66 is shown to be adjacent to the face of the mask 12. The frame fixing portion 64 is shown to be a little bit further away from the face of the mask 12. The spring fixing portion 66 is shown to be adjacent to the left edge of the mask 12. The frame fixing portion 64 is shown to be a little bit further away from the left edge of the mask 12.

The uni-metal is formed by integrally extending from one of the low and high expansion members. Preferably, the high expansion member is formed of an SUS-type material. The SUS-type material is a stainless steel material. The term “SUS” refers to a category or standard related to the Siam United Steel Company. Stainless steel has a high thermal expansion coefficient. A different material other than stainless steel can be used in the present invention, as long as the different material has a high thermal expansion property.

Preferably, the low expansion member is formed of an INVAR-type material having a low thermal expansion property. INVAR steel is Fe-36Ni alloy. A different material other than INVAR can be used in the present invention, as long as the different material has a low thermal expansion property.

By integrally forming the uni-metal and the bimetal, the durability of the spring holder 16a can be enhanced when compared with a spring holder having a uni-metal and a bimetal separately manufactured and then attached to each other. The spring holder 16a has the integrally formed uni-metal and bimetal. Thus, the spring holder 16a is more durable than a spring holder having uni-metal and bimetal separately manufactured and then attached to each other. In other words, the spring holder 16a is more durable than a spring holder having uni-metal and bimetal not integrally formed. The uni-metal is a substance substantially comprising one metal. The bimetal is a substance substantially comprising at least two different metals.

Such spring holders 16a are mounted on the mask frame such that the bimetals and the uni-metals are arranged in a variety of manners according to the tension value of the tensioned mask and the structure of the mask frame. In this embodiment, as shown in FIGS. 2B and 2C, the spring fixing portion B is formed with the bimetal, and the frame fixing portion A is formed with the uni-metal.

As shown in FIG. 2B, the spring holders 16a mounted on the supporting members 14a of the mask frame 14 are disposed such that the low expansion members 16a″ face the inner side of the mask frame 14. As shown in FIG. 2C, the spring holders 16a mounted on the elastic members 14b are disposed such that the high expansion members 16a′ face the inner side of the mask frame 14 and such that the low expansion members 16a″ do not face the inner side of the mask frame 14. The line L shown in FIG. 2C separates the frame fixing portion A from the spring fixing portion B.

When thermal energy is increased by the electron beam scanning and the high current aging in a state where the shadow mask assembly is mounted inside the panel using the spring assemblies 16, the spring holders 16a are flexed in directions indicated by arrows in FIG. 2A, thereby compensating for thermal expansion of the shadow mask 12 and the mask frame 14.

The FIGS. 2D to 2G illustrate various exploded views of the spring holder and related components shown in FIG. 2C, in accordance with the principles of the present invention. The FIG. 2H shows a modified example of the arrangement of the spring holder and related components shown in FIG. 2C, in accordance with the principles of the present invention. The FIGS. 2I and 2J show a modified example of the spring holder shown in FIG. 2C, in accordance with the principles of the present invention.

In FIG. 2D, the spring holder 16a is shown in an exploded view, with the low expansion member 16a″ not yet connected to the high expansion member 16a′. Also in FIG. 2D, the elastic member 14b is shown close to its final position, before the spring holder 16a has been connected to the elastic member 14b. The frame fixing portion A is uni-metal, because it includes only the upper part of the high expansion member 16a′. The spring fixing portion B is bimetal, because it includes the lower right part of the high expansion member 16a′ and also includes the entire low expansion member 16a″.

In FIG. 2E, the spring holder 16a is shown in the final form where the high expansion member 16a′ has already been connected to the low expansion member 16a″. The FIG. 2E clearly shows that the upper uni-metal portion is integrally formed with the lower bimetal portion. As shown in FIG. 2E, the high expansion member 16a′ has a wide upper section and has a narrow lower section that extends down from the upper section. The wide upper section of the high expansion member 16a′ corresponds to the uni-metal portion of the spring holder 16a. The narrow lower section of the high expansion member 16a′ is joined by the low expansion member 16a″ to form the bimetal portion in the lower part of the spring holder 16a.

The spring holder 16a shown in FIG. 2B is oriented upside down in comparison to the spring holder 16a shown in FIG. 2E. In other words, the spring holder 16a shown in FIG. 2B illustrates a high expansion member 16a′ having a wide lower section and having a narrow upper section that extends up from the lower section. In FIG. 2B, the wide lower section of the high expansion member 16a′ corresponds to the uni-metal portion of the spring holder 16a. In FIG. 2B, the narrow upper section of the high expansion member 16a′ is joined by the low expansion member 16a″ to form the bimetal portion in the upper part of the spring holder 16a.

In FIG. 2F, the spring 16b and the elastic member 14b are being connected to the spring holder 16a. The spring 16b has a hole 16c. A stud in a cathode ray tube panel will be received by the hole 16c, in order to hold the shadow mask 12 to the cathode ray tube panel. In FIG. 2G, the spring holder 16a is shown connected to the spring 16b and to the elastic member 14b.

In FIG. 2H, the frame fixing portion A is shown, the spring fixing portion B is shown, and a middle portion C is shown. The frame fixing portion A is the portion of the spring holder 16a which is used to attach the elastic member 14b to the spring holder 16a. The frame fixing portion A is uni-metal, because it only includes high expansion member 16a′. The spring fixing portion B is the portion of the spring holder 16a which is used to attach the spring 16b to the spring holder 16a. The spring fixing portion B is bimetal, because it includes the high expansion member 16a′ and the low expansion member 16a″. The middle portion C is a portion of the spring holder 16a which is located between the frame fixing portion A and the spring fixing portion B. The middle portion C can have a variety of different configurations. For example, the middle portion C can be completely uni-metal, when it is composed of only the high expansion member 16a′. Or the middle portion C can be completely bimetal, when it includes both the low and high expansion members 16a″ and 16a′. Or the middle portion C can be partly uni-metal and partly bimetal, as shown in FIG. 2H. As shown in FIG. 2H, the frame fixing portion A is not required to have contact with the spring fixing portion B. The middle portion C can be any intervening region separating frame fixing portion A and spring fixing portion B.

In FIGS. 2I and 2J, a different type of spring holder 16a is shown, in accordance with the principles of the present invention. As shown in FIGS. 2I and 2J, the spring holder 16a includes a low expansion member 16a″, a first high expansion member 16a′(1), and a second high expansion member 16a′(2). These three components are connected together to form a spring holder 16a. The spring holder 16a shown in FIGS. 2I and 2J is different from the spring holders 16a shown in FIGS. 2C to 2H, because the spring holder 16a in FIGS. 2I and 2J has three different metal parts connected to each other. The spring holders 16a shown in FIGS. 2C to 2H only have two different metal parts connected to each other. In FIGS. 2I and 2J, the first and second high expansion members 16a′(1) and 16a′(2) can be composed of the same material. Alternatively, the high expansion members can be composed of different materials. The materials in the first and second high expansion members 16a′(1) and 16a′(2) are materials having a high thermal expansion coefficient. In FIGS. 2I and 2J, the upper uni-metal portion 16a′(1) is not integrally formed with the lower bimetal portion in the same way that the upper uni-metal portion 16a′ is integrally formed with the lower bimetal portion shown in the spring holder 16a shown in FIGS. 2C to 2G.

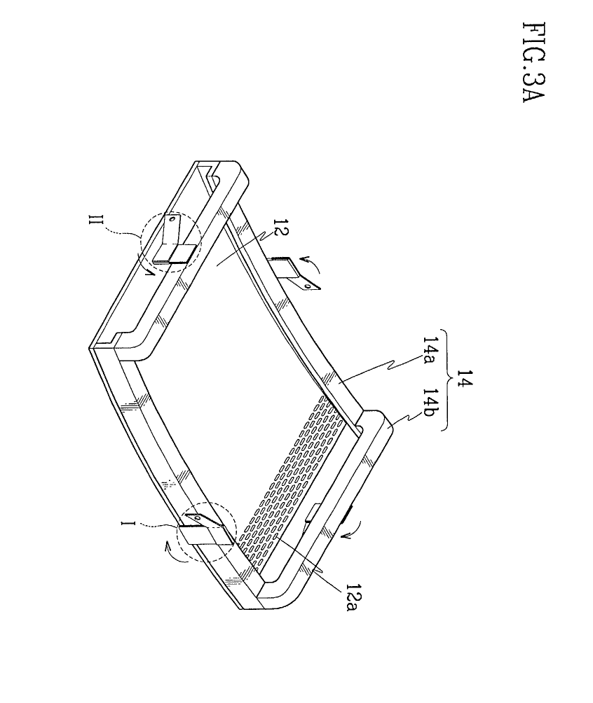

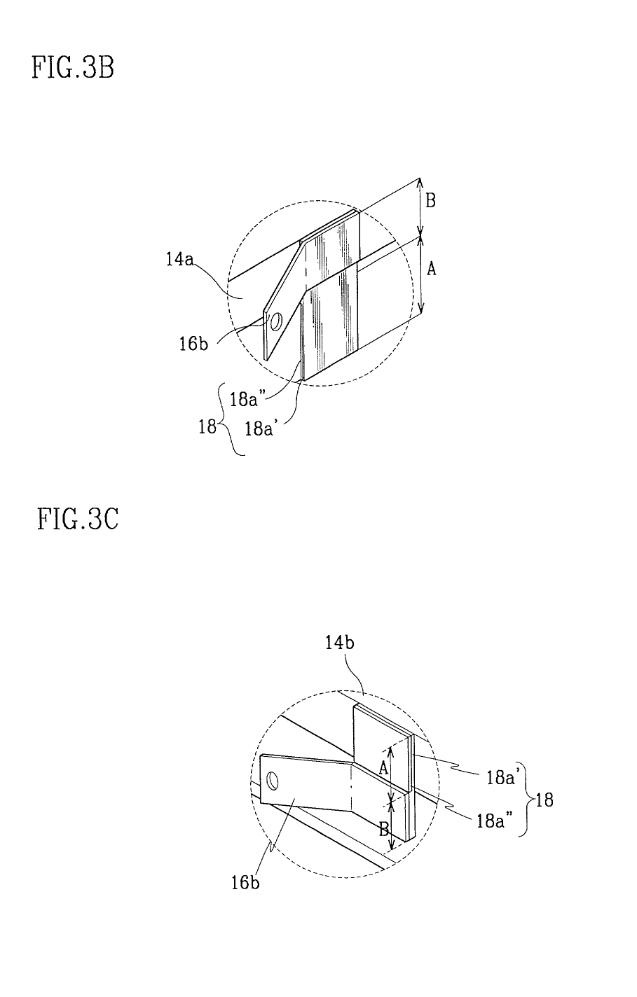

FIGS. 3A to 3C show a shadow mask assembly of a color cathode ray tube according to a second embodiment of the present invention. A shadow mask assembly of this embodiment is substantially identical to that of the first embodiment except for a structure of a spring holder. Therefore, only a structure of the spring holder will be described hereinafter.

In the first embodiment shown in FIGS. 2A to 2C, the spring fixing portion B is formed of the bimetal. Therefore, the amount of thermal expansion compensation of the overall spring holder from an end of the frame fixing portion to an end of the spring fixing portion is less than that of a spring holder having a frame fixing portion formed of a bimetal.

That is, when assuming that deformation amounts of the bimetals are identical to each other, when the spring fixing portion is formed of the bimetal, since the deformation reference point of the spring holder is located at a point where the spring fixing portion and the frame fixing portion are connected to each other, the overall amount of the compensation of the spring holder is limited to the amount of the compensation of the spring fixing portion. However, when the frame fixing portion is formed of the bimetal, since the deformation reference point of the spring holder is located at the end of the frame fixing portion, the overall amount of the compensation of the spring holder becomes the sum of the amount of the compensation of the frame fixing portion and the amount of the compensation of the spring fixing portion cooperating with the deformation of the frame fixing portion.

Accordingly, in this embodiment, as shown in FIGS. 3B and 3C, the spring holder 18 is manufactured such that the spring fixing portion B is formed of a uni-metal, while the frame fixing portion A is formed of a bimetal. As shown in FIG. 3B, the spring holders 18 mounted on the supporting members 14a of the mask frame 14 are disposed such that the low expansion members 18a″ of the frame fixing portions A face the inner side of the mask frame 14. As shown in FIG. 3C, the spring holders 18 mounted on the elastic members 14b are disposed such that the high expansion members 18a′ face the inner side of the mask frame 14.

As described above, when the frame fixing portion A is formed of the bimetal, the overall amount of thermal expansion compensation of the spring holder 18 is increased when compared with the first embodiment.

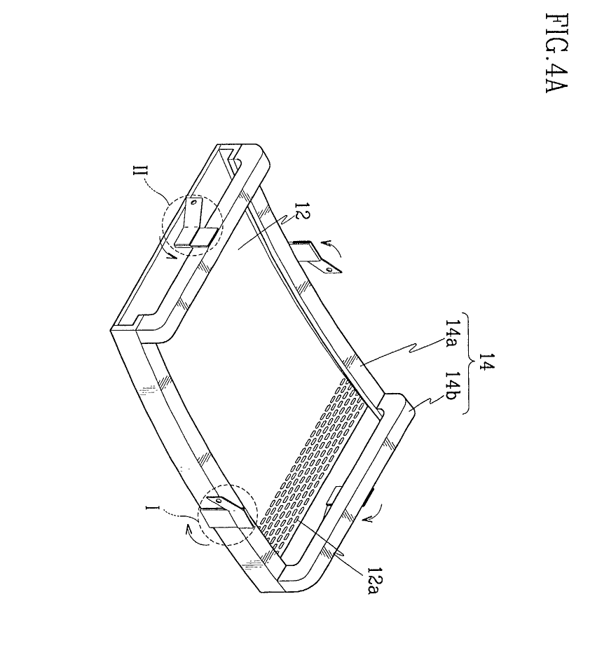

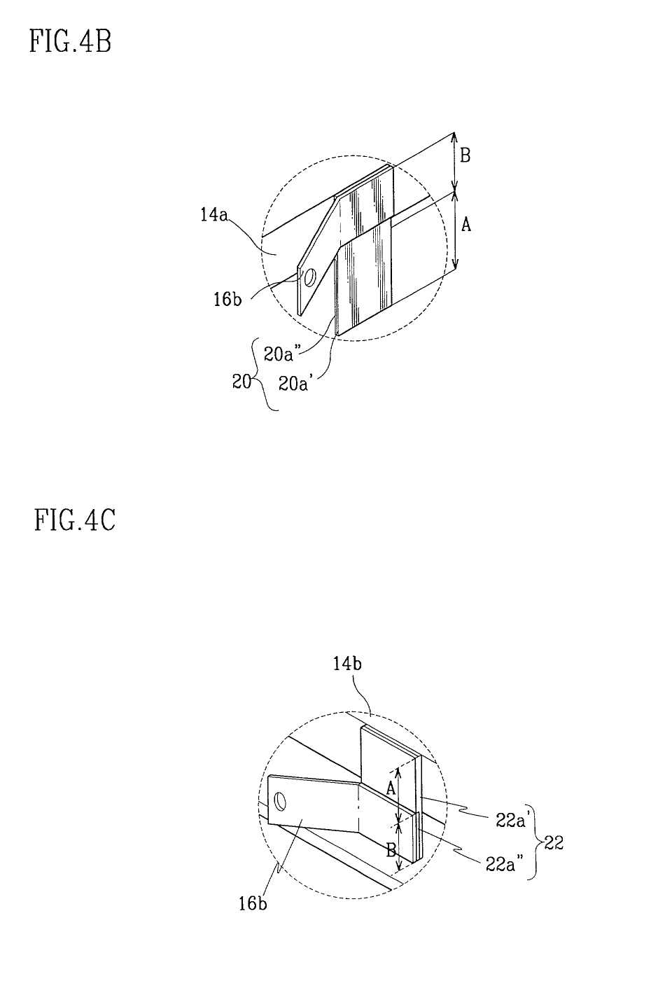

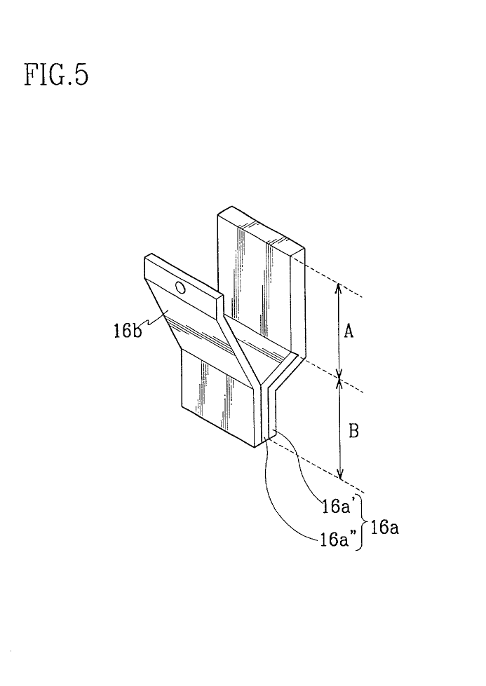

FIGS. 4A to 4C show a shadow mask assembly of a color cathode ray tube according to a third embodiment of the present invention. A shadow mask assembly of this embodiment is substantially identical to those of the first and second embodiments except for a structure of a spring holder. Therefore, only the structure of the spring holder will be described hereinafter.

In the first and second embodiments, all of the spring holders 16a (18) are identically structured each having one of the spring fixing portion B and the frame fixing portion A is formed of the bimetal.

However, in the third embodiment, spring holders 20 mounted on the supporting members 14a are formed having frame fixing portions A formed of bimetals, and spring holders 22 mounted on the elastic members 14b are formed having spring fixing portions B formed of bimetals. Spring holder 20 comprises low expansion member 20a″ and high expansion member 20a′.

As shown in FIG. 4B, the spring holders 20 mounted on the supporting members 14a of the mask frame 14 are disposed such that the low expansion members 20a″ of the frame fixing portion A face the inner side of the mask frame 14. As shown in FIG. 4C, the spring holders 22 mounted on the elastic members 14b are disposed such that the high expansion members 22a′ face the inner side of the mask frame 14. Spring holder 22 comprises low expansion member 22a″ and high expansion member 22a′.

When the spring holders 20 and 22 are disposed as described above, the amount of thermal expansion compensation can be accurately adjusted.

In the above embodiments, an amount of thermal expansion compensation can be varied by varying the length of the bimetal when manufacturing the spring holders.

In accordance with the principles of the present invention, the first embodiment is as follows, with reference to FIGS. 2A to 2C. A shadow mask frame 14 has elastic members 14b with spring holders, and has supporting members 14a with spring holders. The spring holders 16a on the elastic members 14b have a spring fixing portion B that is bimetal and a frame fixing portion A that is uni-metal. The spring holders 16a on the supporting members 14a have a spring fixing portion B that is bimetal and a frame fixing portion A that is uni-metal.

In accordance with the principles of the present invention, the second embodiment is as follows, with reference to FIGS. 3A to 3C. A shadow mask frame 14 has elastic members 14b with spring holders, and has supporting members 14a with spring holders. The spring holders 16a on the elastic members 14b have a spring fixing portion B that is uni-metal and a frame fixing portion A that is bimetal. The spring holders 16a on the supporting members 14a have a spring fixing portion B that is uni-metal and a frame fixing portion A that is bimetal.

In accordance with the principles of the present invention, the third embodiment is as follows, with reference to FIGS. 4A to 4C. A shadow mask frame 14 has elastic members 14b with spring holders, and has supporting members 14a with spring holders. The third embodiment can have either one of the following two configurations. In the first configuration of the third embodiment, the spring fixing portion B of the spring holder 16a on the elastic member 14b will be bimetal, the frame fixing portion A of the spring holder 16a on the elastic member 14b will be uni-metal, the spring fixing portion B of the spring holder 16a on the supporting member 14a will be uni-metal, and the frame fixing portion A of the spring holder 16a on the supporting member 14a will be bimetal. In the second configuration of the third embodiment, the spring fixing portion B of the spring holder 16a on the elastic member 14b will be uni-metal, the frame fixing portion A of the spring holder 16a on the elastic member 14b will be bimetal, the spring fixing portion B of the spring holder 16a on the supporting member 14a will be bimetal, and the frame fixing portion A of the spring holder 16a on the supporting member 14a will be uni-metal.

There is a hybrid embodiment of the present invention in which the two spring holders 16a on the elastic members 14b can be different than the two spring holders on the supporting members 14a, in accordance with the principles of the present invention. More particularly, the two spring holders 16a on the elastic members 14b can be configured to be partly bimetal and partly uni-metal, as shown in FIG. 2C, and the configuration of the two spring holders on the supporting members 14b is not required to be partly bimetal and partly uni-metal. In other words, the two spring holders 16a on the elastic members 14b are required to be partly uni-metal and partly bimetal, but the two spring holders on the supporting members 14a can be completely uni-metal, or completely bimetal, or some other configuration. Thus, the spring holders 16a on the elastic members 14b are as shown in FIG. 2C, but the spring holders on the supporting members 14a do not need to be identical to the spring holder 16a shown in FIG. 2B, according to the hybrid embodiment of the present invention.

In accordance with the principles of the present invention, the hybrid embodiment is as follows, with reference to FIGS. 2A and 2C. A shadow mask frame 14 has elastic members 14b with spring holders 16a, and the spring holders 16a can have any one of the two following configurations. First, the spring fixing portion B of the spring holder 16a will be bimetal when the frame fixing portion A of the spring holder 16a is uni-metal. Second, the spring fixing portion B will be uni-metal when the frame fixing portion A is bimetal. In this hybrid embodiment, the configurations of any spring holders on the supporting members 14a is not important.

As shown in FIGS. 2A to 4C, the spring fixing portion B and the frame fixing portion A are formed on the same plane in the first, second, and third embodiments, and also in the hybrid embodiment. As shown in FIG. 5, a spring fixing portion B may be formed to be bent toward the inner surface of the panel from the frame fixing portion A. FIG. 5 shows spring 16b, spring holder 16a, high expansion member 16a′, and low expansion member 16a″. In FIG. 5, the spring fixing portion and the frame fixing portion are not limited to being in the same plane. The teachings of FIG. 5 can be applied to the first, second, and third embodiments, and to the hybrid embodiment. Accordingly, the corresponding fixing portions in the hybrid, first, second, and third embodiments can also be not limited to being in the same plane.

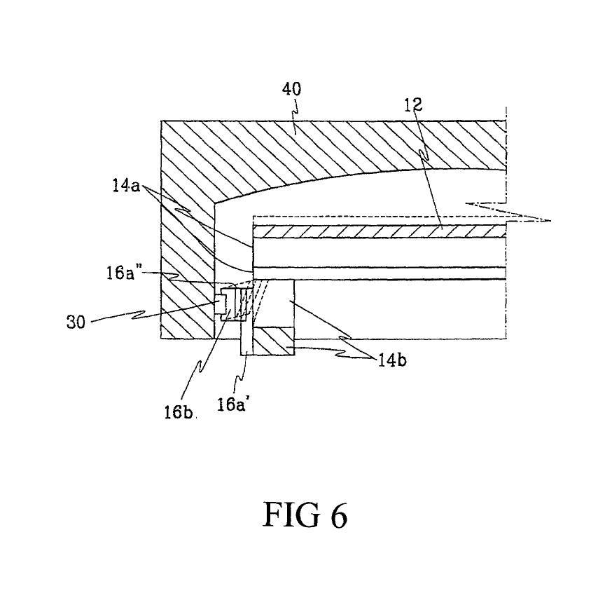

FIG. 6 is a view of a cathode ray tube panel having a stud pin, in accordance with the principles of the present invention. FIG. 6 shows a cathode ray tube panel 40, a stud pin 30 installed in the panel 40, and a transformed condition of a spring holder 16a (shown in dotted line). FIG. 6 also shows shadow mask 12, supporting member 14a of mask frame 14, low expansion member 16a″ of spring holder 16a, spring 16b, high expansion member 16a′ of spring holder 16a, and elastic member 14b of mask frame 14. The spring 16b has a hole 16c, as shown in FIG. 2C, for example. The stud pin 30 penetrates the hole 16c in order to support the mask frame 14 on an inner surface of the cathode ray tube panel 40.

Among other things, the present invention teaches that, in the inventive spring holder, the spring fixing portion and the frame fixing portion will not have the same type of metal structure. In other words, when the spring fixing portion B is uni-metal, then the frame fixing portion A must be bimetal. And when the spring fixing portion B is uni-metal, then the frame fixing portion A must be bimetal.

As described above, the amount of thermal expansion compensation of the mask assembly can be variously designed by varying the length of the bimetal or varying the disposition of the bimetal of the spring holder.

Accordingly, the amount of thermal expansion compensation can be easily set in a variety of designs according to a manufacturing company and a model.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A shadow mask apparatus, comprising:
a color selection electrode forming a plurality of beam-passing apertures;
a mask frame supporting said color selection electrode and having a tensioning device applying tension to said color selection electrode;
at least one primary spring holder mounted on said mask frame, said at least one primary spring holder having a primary spring fixing portion and a primary frame fixing portion, one of said two primary portions being formed of a bimetal and the other one of said two primary portions being formed of a uni-metal, said primary frame fixing portion being secured to said mask frame; and
a first spring being secured to said primary spring fixing portion and being coupled to a cathode ray tube panel, said first spring supporting said mask frame on the cathode ray tube panel;
said tensioning device comprising two elastic members, said at least one primary spring holder including a first primary spring holder and a second primary spring holder, said first primary spring holder being mounted on one of said two elastic members and said second primary spring holder being mounted on the other one of said two elastic members.

2. The apparatus of claim 1, further comprising at least one secondary spring holder mounted on said mask frame, said at least one secondary spring holder having a secondary spring fixing portion and a secondary frame fixing portion, said mask frame having a supporting device connected to said color selection electrode to support said color selection electrode, said secondary frame fixing portion of said at least one secondary spring holder being secured to said supporting device of said mask frame.

3. The apparatus of claim 1, said mask frame having a supporting device connected to said color selection electrode to support said color selection electrode.

4. The apparatus of claim 3, said color selection electrode being oriented in a second direction to have an upper edge at a top of said color selection electrode and a lower edge at a bottom of said color selection electrode, said supporting device having a first supporting member positioned in a first direction to support said upper edge and having a second supporting member positioned in the first direction to support said lower edge, the first direction being substantially perpendicular to the second direction.

5. The apparatus of claim 4, said tensioning device having at least one elastic member extending in the second direction, said at least one elastic member being connected to said first and second supporting members of said supporting device, said at least one elastic member applying the tension to said color selection electrode.

6. The apparatus of claim 5, said two primary portions being arranged to be one over the other, in a third direction substantially perpendicular to the second and first directions.

7. The apparatus of claim 6, the bimetal of said at least one primary spring holder including a low expansion member and a high expansion member, said low and high expansion members being attached to each other side by side in the first direction, said low expansion member expanding at a first rate in response to thermal energy, said high expansion member expanding at a second rate in response to the thermal energy, said first rate being slower than said second rate.

8. The apparatus of claim 7, said at least one primary spring holder being mounted on said elastic member with said high expansion member of the bimetal facing in the first direction substantially toward a central region of said color selection electrode and with said low expansion member of the bimetal facing in the first direction substantially away from the central region of said color selection electrode.

9. The apparatus of claim 7, said at least one primary spring holder being mounted on an outer side of said elastic member with said high expansion member of the bimetal facing in the first direction substantially toward an inner side of said mask frame and with said low expansion member of the bimetal facing in the first direction substantially away from the inner side of said mask frame.

10. The apparatus of claim 9, said high expansion member being formed of a stainless steel-type material.

11. The apparatus of claim 9, said low expansion member being formed of an INVAR-type material.

12. A shadow mask apparatus, comprising:
a color selection electrode forming a plurality of beam-passing apertures;
a mask frame supporting said color selection electrode and having a tensioning device applying tension to said color selection electrode;
a first primary spring holder having a first primary spring fixing portion and a first primary frame fixing portion, said first primary frame fixing portion being secured to said tensioning device of said mask frame;
a second primary spring holder having a second primary spring fixing portion and a second primary frame fixing portion, said second primary frame fixing portion being secured to said tensioning device of said mask frame;
a first spring being secured to said first primary spring fixing portion and being coupled to a cathode ray tube panel, said first spring supporting said mask frame on the cathode ray tube panel; and
a second spring being secured to said second primary spring fixing portion and being coupled to the cathode ray tube panel, said second spring supporting said mask frame on the cathode ray tube panel;
one portion selected from among said first primary frame fixing portion and said first primary spring fixing portion being formed of a bimetal and the other portion being formed of a uni-metal, one portion selected from among said second primary frame fixing portion and said second primary spring fixing portion being formed of a bimetal and the other portion being formed of a uni-metal;
said tensioning device comprising two elastic members, said first primary spring holder being mounted on one of said two elastic members and said second primary spring holder being mounted on the other one of said two elastic members.

13. The apparatus of claim 12, said mask frame having a supporting device connected to said color selection electrode to support said color selection electrode, said color selection electrode being oriented in a second direction to have an upper edge at a top of said color selection electrode and a lower edge at a bottom of said color selection electrode, said supporting device having a first supporting member positioned in a first direction to support said upper edge and having a second supporting member positioned in the first direction to support said lower edge, the first direction being substantially perpendicular to the second direction, said two elastic members extending in the second direction, each one of said two elastic members being connected to said first and second supporting members of said supporting device, said two elastic members applying the tension to said color selection electrode.

14. The apparatus of claim 13, said two elastic members extending in the second direction, said first primary spring fixing portion and said first primary frame fixing portion being arranged to be one over the other, aligned in a third direction substantially perpendicular to the second and first directions.

15. The apparatus of claim 14, the bimetal of said first primary spring holder including a low expansion member and a high expansion member, said low and high expansion members being attached to each other side by side in the first direction, said low expansion member expanding at a first rate in response to thermal energy, said high expansion member expanding at a second rate in response to the thermal energy, said first rate being slower than said second rate.

16. The apparatus of claim 15, said first primary spring holder being mounted on one of said two elastic members with said high expansion member of the bimetal facing in the first direction substantially toward an inner side of said mask frame and with said low expansion member of the bimetal facing in the first direction substantially away from the inner side of said mask frame.

17. The apparatus of claim 16, the uni-metal of said first primary spring holder and said high expansion member of the bimetal of said first primary spring holder corresponding to one member.

18. The apparatus of claim 17, the uni-metal of said first primary spring holder being integrally formed with said high expansion member of the bimetal of said first primary spring holder.

19. The apparatus of claim 16, the uni-metal of said first primary spring holder being integrally formed with said high expansion member of the bimetal of said first primary spring holder.

20. The apparatus of claim 19, the bimetal of said first primary spring holder corresponding to said first primary spring fixing portion.

21. The apparatus of claim 15, further comprising:
a first secondary spring holder having a first secondary spring fixing portion and a first secondary frame fixing portion, said first secondary frame fixing portion being secured to said first supporting member; and
a third spring being secured to said first secondary spring fixing portion and being coupled to the cathode ray tube panel, said third spring supporting said mask frame on the cathode ray tube panel;
one portion selected from among said first secondary frame fixing portion and said first secondary spring fixing portion being formed of a bimetal and the other portion being formed of a uni-metal, said first secondary spring fixing portion and said first secondary frame fixing portion being arranged to be one over the other, aligned in the third direction substantially perpendicular to the second and first directions.

22. The apparatus of claim 21, the bimetal of said first secondary spring holder including a low expansion member and a high expansion member, said low and high expansion members being attached to each other side by side in the first direction.

23. The apparatus of claim 22, said first secondary spring holder being mounted on said first supporting member with said low expansion member of the bimetal facing in the second direction substantially toward an inner side of said mask frame and with said high expansion member of the bimetal facing in the second direction substantially away from the inner side of said mask frame.

24. The apparatus of claim 23, the uni-metal of said first secondary spring holder and said high expansion member of the bimetal of said first secondary spring holder corresponding to one member.

25. The apparatus of claim 24, the uni-metal of said first secondary spring holder being integrally formed with said high expansion member of the bimetal of said first secondary spring holder.

26. The apparatus of claim 23, the uni-metal of said first secondary holder being integrally formed with said high expansion member of the bimetal of said first secondary spring holder.

27. The apparatus of claim 26, the bimetal of said first secondary spring holder corresponding to said first secondary frame fixing portion.

28. The apparatus of claim 27, said first direction corresponding to a horizontal direction, said second direction corresponding to a vertical direction.
